(19) United States
(12) Patent Application Publication
(10) Pub. No.: US 2012/0160874 A1
(43) Pub. Date: Jun. 28, 2012

(54) PACKAGING AND DISPENSING DEVICE INCLUDING A MINIATURE ELECTRIC PUMP

(75) Inventors: Daniel De Rosa, Louviers (FR); Bruno Lablaine, Thivars (FR)

(73) Assignees: ABN CONCEPT, Chartres (FR); MAITRISE ET INNOVATION, Val de Rueil (FR)

(21) Appl. No.: 13/393,966

(22) PCT Filed: Sep. 6, 2010
(86) PCT No.: PCT/EP10/63027

§ 371 Date: Mar. 2, 2012

(30) Foreign Application Priority Data
Sep. 7, 2009 (FR) 0956059

(51) Int. Cl. B65D 88/54; B05B 9/04; G01F 11/08; B67D 7/62

(52) U.S. Cl. 222/333; 239/332

(57) ABSTRACT

A packaging and dispensing device (10) for a liquid or semi-liquid product, includes: a container (12) including a lining element (18, 20) solidly connected thereto; an outlet member (22) borne by the lining element; and at least one pump (24) connected to (i) at least one inlet duct (26) communicating with an outlet hole (16) in the container, in turn communicating with the interior of the container, and (ii) at least one outlet duct (28) supplying the outlet member. An element (30) for controlling the pump can be activated from an external surface (32) of the lining element in order to control the operation of the pump and the conveying of the product from the container to the outlet member. The pump is a miniature piezoelectric pump which is powered by an electrical power supply unit (34) in the lining element and which is controlled by the control element.

The invention relates to a packaging and dispensing device for a liquid or semi-liquid product.

The invention relates more specifically to a packaging and dispensing device for a liquid or semi-liquid product, comprising a reservoir, a trim element secured to the reservoir, an outlet member borne by the trim element, and at least one pump which is connected firstly to at least one inlet duct communicating with an outlet orifice of the reservoir communicating with the inside of said reservoir, and which is secondly connected to at least one outlet duct feeding the outlet member, a control means for operating the pump being able to be activated from an external surface of the trim element to control the operation of the pump and the conveying of the product from the reservoir to the outlet member.

Numerous examples of packaging devices of this type are known.

Such devices are used for example for dispensing scent, cosmetics, or any active substance such as an insecticide, a cleaning product or even a disinfectant.

Most of these are packaging devices in which the pump is a manual pump and in which the control member consists of a push-button that mechanically operates the pump either directly or by a system of associated cams.

Document DE-A1-38 36 290 discloses a packaging device of the above-mentioned type in which a vertically operated mechanical pump is operated alternately by a cam which is borne by an eccentric turned by an electric motor.

Such a motorized drive device of a conventional mechanical pump is particularly bulky. Indeed the trim element has to accommodate the electric motor and the cam and what is more, these elements have to be set out in a certain way within said trim element in order to operate the manual pump correctly.

Such a configuration therefore precludes any miniaturizing of the packaging device.

What is more, using the cam to motorize an existing mechanical pump with a reciprocating movement allows product to be dispensed only in a sporadic way, this for example being incompatible with spraying through an atomization nozzle. This is because such a nozzle has to be fed at a substantially constant pressure in order to atomize the product optimally.

Finally, an electric motor intended to operate a mechanical pump for actuating a cam has of necessity to be powerful, and therefore draws large amounts of power.

As a result, the electrical power supply for this motor has of necessity to be sized accordingly and is therefore particularly bulky.

The invention therefore proposes a packaging and dispensing device that uses a miniaturized electric pump allowing a consistent delivery of product with a lower electrical power consumption.

To this end, the invention therefore proposes a packaging and dispensing device of the type described hereinabove, characterized in that the pump is a miniature electric pump which is powered by an electrical power supply means housed in the trim element and which pump is controlled by the control means.

According to other features of the invention:
the miniature electric pump is of piezoelectric type,
the electrical power supply means comprises a cell, notably a miniature cell of the lithium cell type,
the electrical power supply means comprises an accumulator battery that can be recharged by means of a source of electrical power,
the electrical power supply means is autonomous and notably comprises a photovoltaic panel or alternatively a manual generator of electrical current of the dynamo type,
the electrical power supply means is connected to an electrical network directly or via a transformer, notably to a domestic AC mains network via a plug and/or a dedicated base station, or alternatively, is connected to a motor vehicle on-board DC electric network via an outlet of the cigarette lighter type, or alternatively a personal computer serial peripheral DC power supply circuit via a so-called “USB” serial connector,
the control means comprises a switch that controls the electrical power supply means,
the control means comprises an electronic circuit forming a switch which is triggered by the stopping-off of a photoelectric cell,
the reservoir comprises at least one neck comprising the outlet orifice, in which is held the pump, of which one end comprises the inlet duct, and of which an opposite end comprises a nozzle for coupling to the outlet duct,
the trim element comprises a cap which is fitted over the reservoir,
the reservoir comprises a nozzle comprising the outlet orifice, which is connected to one end of the inlet duct of which an opposite end is connected to an inlet nozzle of the pump, an opposite end of the pump comprising a nozzle for coupling to the outlet duct, said pump being borne by the trim element,
the pump is borne by an intermediate element secured to the trim element,
the pump is fixed to an internal wall of the trim element,
the miniature pump comprises at least one variable-volume chamber to which the product is admitted via a first membrane that forms a one-way valve and from which the product is ejected via a second membrane that forms a one-way valve, the variable-volume chamber comprising at least one fixed wall and one moving membrane capable of being moved by a piezoelectric actuator in order to cause the volume of the chamber to vary.

Further features and advantages of the invention will become apparent from reading the detailed description which follows, for an understanding of which reference will be made to the attached drawings in which:

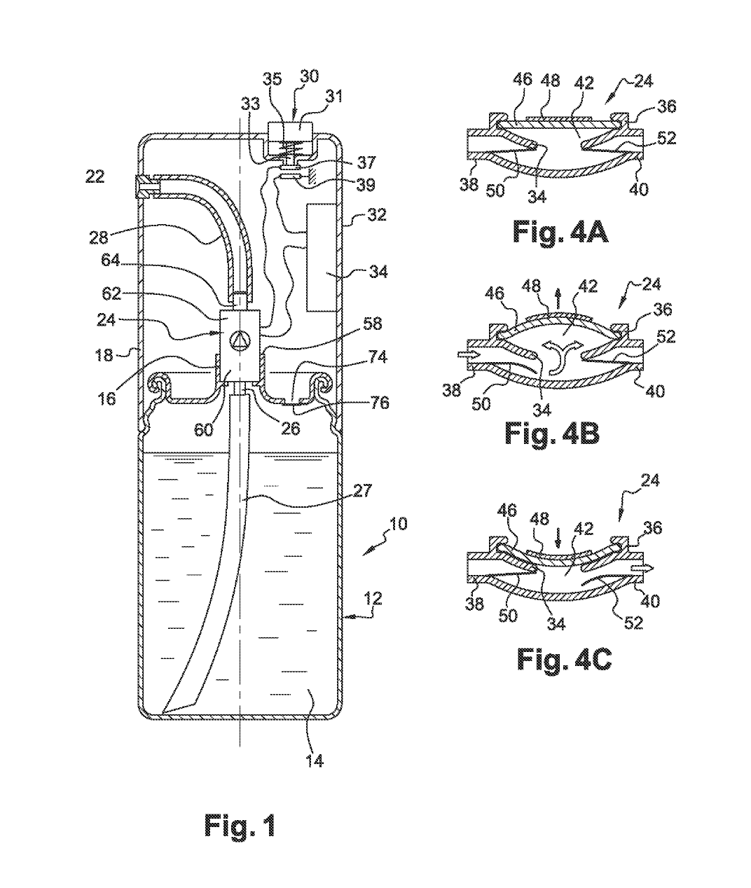

FIG. 1 is a view in cross section of a packaging and dispensing device according to a first embodiment of the invention;

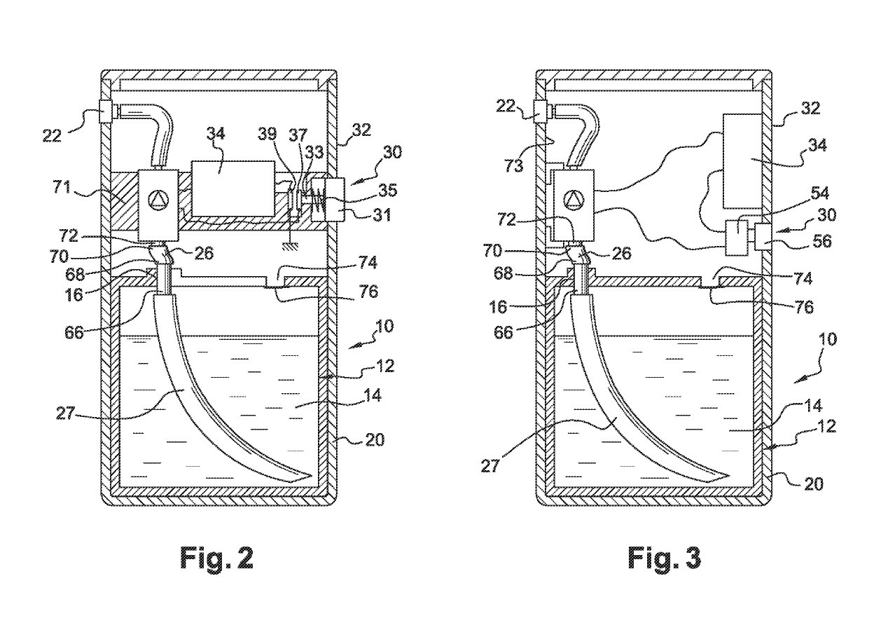

FIG. 2 is a view in cross section of a packaging and dispensing device according to a second embodiment of the invention;

FIG. 3 is view in cross section of a packaging and dispensing device according to a third embodiment of the invention;

FIGS. 4A to 4C are schematic views in cross section of a pump used in the invention depicted in succession in the position of rest, intake and delivery of liquid or semi-liquid product.

In the description that follows, identical reference numerals denote parts that are identical or perform similar functions.

FIGS. 1 to 3 depict a packaging and dispensing device 10 for a liquid or semi-liquid product.

In the known way, the device 10 comprises a reservoir 12 which accommodates the product 14. The reservoir 12 comprises at least one outlet orifice 16 and also preferably comprises an air intake vent 17.

The device also in the known way comprises a trim element 18, 20 attached to the reservoir 12.

For example, as depicted in FIG. 1, the reservoir 12 may be surmounted by a cap 18 that forms the trim element. The reservoir 12 may also, as depicted in FIGS. 2 and 3, be held in a casing 20 that forms the trim element.

In the known way, the device 10 comprises an outlet member 22 which is borne by the trim element 18 or 20.

When used with a liquid product, the outlet member 22 consists of a nozzle forming an atomizer which allows the product to be sprayed in the form of a mist or of fine droplets.

In the case of a product of semi-liquid or creamy consistency, the outlet member for example consists of a nozzle or of an applicator allowing the product to be ejected from the device 10 and applied.

In the known way, the device 10 comprises a pump 24 which is connected firstly to at least one inlet duct 26 which is connected to the outlet orifice 16 of the reservoir 12 to communicate with the inside of said reservoir 12 and which is secondly connected to at least one outlet duct 28 which feeds the outlet member 22.

The inlet duct 26 is notably connected with a dip tube 27 which is immersed inside the reservoir 12 and allows product to be carried from the reservoir 12 to the inlet duct 26.

The reservoir 12 also comprises an air vent 74 that can be stopped off selectively by an associated re-equalizing valve 76.

In the known way, a control means 30 for operating the pump 24 can be activated from an external surface 32 of the trim element 18 or 20 to control operation of the pump 24 and thus cause product to be conveyed from the reservoir 12 to the outlet member 22.

Conventionally, such a packaging device 10 comprises a mechanical pump 24 actuated substantially vertically which is intended to be operated by hand. This is conventionally done using a push-button which constitutes the control means 30. Operating the push-button causes product to be ejected from the outlet member 22.

The disadvantage with this design is that it requires the pump 24 to be actuated a number of times each time the user wishes to eject a large amount of product from the device 10.

According to a design known from document DE-A1-38 36 290, it has been proposed that this known design of the prior art be improved by replacing the conventional push-button control means with an assembly consisting of an electric motor that turns an eccentric cam intended to operate the mechanical pump 24.

This design has the advantage of allowing numerous actuations of the pump 24 and therefore of allowing greater quantities of product to be ejected from the device 10, but nonetheless still has numerous disadvantages.

In particular, actuation of a mechanical pump requires the use of a very powerful electric motor which has therefore of necessity to be powered by an appreciable electrical power supply, notably batteries, which therefore prove to be bulky. The pump has therefore to be designed to operate on a minimum electrical power consumption, which means that any existing pump cannot simply have a motorized drive added to it.

What is more, installing the cam system intended to operate the mechanical pump 24 entails installing this device in a very specific way within the trim element 18 or 20 so that this installation governs the shape of trim used.

Finally, this design has the disadvantage of being particularly unpleasant to use, because the reciprocating movements of the cam transmit to the entire device 10 a series of vibrations that the user can feel while holding the device 10 in their hand.

The invention addresses this disadvantage by proposing a new design of packaging and dispensing device 10 using a pump that does not have the aforementioned disadvantages.

To this end, the invention proposes a device 10 of the type described earlier, characterized in that the pump 24 is a miniature electric pump 24 which is powered by an electrical power supply means 34 and which is controlled by the control means 30.

In the preferred embodiment of the invention, the miniature electric pump is a pump of the piezoelectric type. This configuration does not however limit the invention and the pump could be a miniature piston or vane pump.

Such a piezoelectric pump corresponding to the preferred embodiment of the invention has been depicted schematically in FIGS. 4A to 4C.

In the known way, the piezoelectric pump 24 comprises a housing 36 equipped with an inlet nozzle 38 and with an outlet nozzle 40.

Inside the housing 36 there is a variable-volume chamber 42 which comprises at least one fixed wall 34 and one moving membrane 46 which can be moved by a piezoelectric actuator 48 in order to cause the volume of the chamber 42 to vary.

Products can be admitted to the variable-volume chamber 42 by a first membrane 50 that forms a one-way valve, and can be ejected from the chamber 42 by a second membrane 52 forming a one-way valve.

When the piezoelectric actuator 48 is subjected to an electric current of determined frequency, it is capable of moving to deform the moving membrane 46 into a first configuration, depicted in FIG. 4B, in which the volume of the variable-volume chamber 42 is increased, and in which product can thus be admitted through the inlet nozzle 38 and the first valve-forming membrane 50.

The piezoelectric actuator 48 is also capable of being moved in such a way that the moving membrane 46 occupies a second configuration in which the variable-volume chamber 42 experiences a reduction in its volume, as illustrated by FIG. 4C. The product contained in the chamber 42 is therefore ejected through the second membrane 52 and the outlet nozzle 40.

Moreover, such a pump 24 may comprise one or more chambers 42, generally arranged in series.

For correct implementation of the invention use will preferably be made of a commercially available piezoelectric pump, said pump for example comprising, and in a way that does not limit the invention, two chambers 42 arranged in series and having the advantage of a small size and a low electrical power consumption.

Thus, such a pump may occupy a maximum of 30 millimeters of space for a weight of 2 grams with an electrical power consumption of less than 200 milliwatts.

It can produce a delivery of 6 milliliters per minute at 550 millibar pressure when subjected to a sinusoidal current at a frequency of 100 Hz.

Of course, it is also possible to use a single-chamber pump, likewise commercially available.

There are various conceivable arrangements for producing the means 34 of electrically powering the pump 24.

According to a first embodiment of the invention, the electrical power supply means 34 comprises a cell, for example a miniature cell, of the lithium cell type.

Such a type of cell is particularly suited to the device 10 according to the invention when this device is not designed to be recharged. In such a case, the life of the cell more or less corresponds to the total electrical power consumed by the pump 24 in order to dispense the entire contents of the reservoir 12.

According to another embodiment of the electrical power supply means 34, as depicted in FIGS. 1 to 3, the electrical power supply means 34 may comprise an accumulator which is rechargeable from at least one source of electrical power (not depicted).

According to a first embodiment of the electrical power supply means 34, the latter may, as an alternative, comprise a photovoltaic panel (not depicted) which is preferably placed on the surface 32 of the trim element 18 or 20 so as to allow the accumulator 34 to be recharged when the device 10 is not being used.

The electrical power supply means 34 may also comprise a manual generator of current of the dynamo type (not depicted) which can be incorporated into the trim element 18 or 20 to allow the accumulator to be recharged.

In this case, it will be understood that the trim element 18 or 20 must be designed to incorporate a space (not depicted) to house the generator and a fold-out cranking handle or trigger (not depicted) for operating said generator in order to allow the accumulator 34 to be recharged.

According to a second embodiment of the electrical power supply means, the latter is notably connected to an existing electrical network.

For example, the electrical network consists of a domestic AC mains supply network.

In this case, the rechargeable accumulator 34 of the device 10 can be recharged by connecting the rechargeable accumulator 34 to a transformer connected to said domestic mains network.

To this end, a socket (not depicted) may be provided on the surface 32 of the trim element 18 or 20 and designed to accept a plug connector from the transformer, or alternatively, terminals intended to allow the device 10 to be received in a suitable base station may also be provided on the surface 32 of the trim element 18 or 20, said base station itself having a transformer connected to the mains electricity.

For example, the trim element could have terminals compatible with a mobile phone charging station.

As an alternative, the electrical network may also be a motor vehicle DC on-board electric network, the rechargeable accumulator 34 then being connected to a plug of the cigarette lighter type (not depicted) intended to be connected to the onboard electric network of said motor vehicle.

Finally, the electric network may also be a personal computer serial peripheral DC power supply circuit and in that case the device 10 may have what is known as a “USB” serial connector intended to be inserted into a corresponding USB port of a personal computer so that the rechargeable accumulator 34 can be recharged.

In the preferred embodiment of the invention, as depicted in FIGS. 1 and 2, the control means 30 comprises a switch controlling the electrical power supply means 34.

This is notably a switch of the push-button type protruding from the surface 32 of the trim element 18 or 20.

The switch 30 comprises a push button 31, mounted to slide on a spindle 33 and returned elastically by a spring 35. The button 31 is secured to a terminal 37 able to come into contact with another terminal 39 to close the power supply circuit of the pump 24.

As an alternative, as illustrated by FIG. 3, the control means 30 may comprise an electronic circuit 54 that forms a switch associated with a photoelectric cell 56 arranged on the surface 32 of the trim element 18 or 20.

The stopping-off of the photoelectric cell 56 by the hand of a user taking hold of the device 10 activates the electronic circuit 54 which triggers the application of power to the pump 24.

It will of course be appreciated that other configurations of the control means 30 are conceivable without limiting the scope of the invention. For example, voice control or proximity detection control which is of particular benefit in the case of a device used to package a cosmetic product that is to be applied to the skin, detection of the proximity of the user's skin then being able to initiate the dispensing of the product 14.

In a first embodiment of the invention which has been depicted in FIG. 1, the reservoir 12 comprises at least one neck 58 comprising the outlet orifice 16 and in which the pump 24 is housed.

One end 60 of the pump comprises the inlet duct 26 which is connected to the dip tube 27.

An opposite end 62 of the pump comprises a nozzle 64 for coupling to the outlet duct 28.

In this configuration, the trim element 18 consists of a cap which is preferably fitted over the reservoir 12.

This configuration for example allows a transparent reservoir 12 to be trimmed in a simple way, allowing visual access to the level of the product 14 it contains.

In the second and third embodiments of the invention which have been depicted in FIGS. 2 and 3, the reservoir 12 comprises a nozzle 66 which is connected to one end 68 of the inlet duct 26. An opposite end 70 of the duct 26 is connected to an inlet nozzle 72 of the pump 24.

An opposite end 62 of the pump comprises a nozzle 64 for coupling to the outlet duct 28 which is itself coupled to the outlet member 22.

In both of these two embodiments, the pump 24 is borne by the trim element 20.

More specifically, according to a second embodiment of the invention which has been depicted in FIG. 2, the trim element 20 accepts an intermediate element 71 which is borne by the trim element 20 and which accepts at least the pump 24.

It will be appreciated that, for preference, said intermediate element, where possible, houses the electrical power supply means 34 and the control means 30, as depicted in FIG. 2.

As an alternative, according to a third embodiment which has been depicted in FIG. 3, the pump 24 is fixed to an internal wall 73 of the trim element 20, for example as a close or bonded fit.

It will be appreciated that, in this third embodiment of the invention, all of the internal parts of the device 10, notably the electrical power supply means 34 and the control means 30 are themselves likewise fixed preferably directly to the trim element 20.

The invention therefore makes it possible to offer, in a very simple way, a packaging device for a liquid or semi-liquid product comprising a piezoelectric pump 24 of small size that allows optimum dispensing of the product while at the same time, because of its having been miniaturized, allowing a wide variety of packaging styles.

1. A packaging and dispensing device (10) for a liquid or semi-liquid product, comprising a reservoir (12) comprising a trim element (18, 20) secured to the reservoir (12), an outlet member (22) borne by the trim element (18, 20), and at least one pump (24) which is connected firstly to at least one inlet duct (26) communicating with an outlet orifice (16) of the reservoir communicating with the inside of said reservoir (12), and which is secondly connected to at least one outlet duct (28) feeding the outlet member (22), a control means (30) for operating the pump (24) being able to be activated from an external surface (32) of the trim element (18, 20) to control the operation of the pump (24) and the conveying of the product from the reservoir (12) to the outlet member (22), the pump being a miniature electric pump which is powered by an electrical power supply means (34) housed in the trim element (18, 20) and which pump is controlled by the control means (30),characterized in that the reservoir (12) comprises a nozzle (66) comprising the outlet orifice (16), which is connected to one end (68) of the inlet duct (26) of which an opposite end (70) is connected to an inlet nozzle (72) of the pump (24), an opposite end (62) of the pump (24) comprising a nozzle (64) for coupling to the outlet duct (28), said pump (24) being borne by the trim element (20).

2. The packaging and dispensing device (10) as claimed in claim 1, characterized in that the miniature electric pump (24) is of piezoelectric type.

3. The packaging and dispensing device (10) as claimed in claim 1, characterized in that the electrical power supply means (34) comprises a cell, notably a miniature cell of the lithium cell type.

4. The packaging and dispensing device (10) as claimed in claim 1, characterized in that the electrical power supply means (34) comprises an accumulator battery that can be recharged by means of a source of electrical power.

5. The packaging device (10) as claimed in claim 1, characterized in that the electrical power supply means (34) is autonomous and notably comprises a photovoltaic panel or alternatively a manual generator of electrical current of the dynamo type.

6. The packaging device (10) as claimed in claim 4, characterized in that the electrical power supply means (34) is connected to an electrical network directly or via a transformer, notably to a domestic AC mains network via a plug and/or a dedicated base station, or alternatively, is connected to a motor vehicle on-board DC electric network via an outlet of the cigarette lighter type, or alternatively a personal computer serial peripheral DC power supply circuit via a so-called “USB” serial connector.

7. The packaging device (10) as claimed in claim 1, characterized in that the control means comprises a switch (31, 33, 35, 37, 39) that controls the electrical power supply means (34).

8. The packaging device (10) as claimed in claim 1, characterized in that the control means (30) comprises an electronic circuit (54) forming a switch which is triggered by the stopping-off of a photoelectric cell (56).

9. The device (10) as claimed in claim 1, characterized in that the pump (24) is borne by an intermediate element (71) secured to the trim element (20).

10. The device as claimed in claim 8, characterized in that the pump (24) is fixed to an internal wall (73) of the trim element (20).

11. The device (10) as claimed in claim 1, characterized in that the miniature pump (24) comprises at least one variable-volume chamber (42) to which the product is admitted via a first membrane (50) that forms a one-way valve and from which the product is ejected via a second membrane (52) that forms a one-way valve, the variable-volume chamber (42) comprising at least one fixed wall (34) and one moving membrane (46) capable of being moved by a piezoelectric actuator (48) in order to cause the volume of the chamber (42) to vary.
